(19) United States
(12) Patent Application Publication
(10) Pub. No.: US 2023/0379823 A1
(43) Pub. Date: Nov. 23, 2023

(54) METHODS FOR WAKE UP SIGNAL COMMUNICATION, RELATED RADIO ACCESS NETWORK NODES, RELATED WIRELESS DEVICES AND RELATED CORE NETWORK NODES

(71) Applicant: Sony Group Corporation, Tokyo (JP)

(72) Inventors: Anders BERGGREN, Lund (SE); Basuki PRIYANTO, Lund (SE); Nafiseh MAZLOUM, Lund (SE); Torgny PALENIUS, Barsebäck (SE)

(21) Appl. No.: 17/913,410

(22) PCT Filed: Mar. 9, 2021
(86) PCT No.: PCT/EP2021/055855

§ 371 Date: Sep. 21, 2022

(30) Foreign Application Priority Data
Apr. 9, 2020 (SE) 2050406-4

(51) Int. Cl. H04W 52/02; H04W 68/02

(52) U.S. Cl. CPC H04W 52/0229; H04W 68/02

(57) ABSTRACT

Disclosed is a method performed by a Radio Access Network, RAN, node for Wake Up Signal, WUS, transmission according to the disclosure. The method comprises broadcasting information indicative of a WUS group for use in paging escalation. The method comprises receiving, from a core network node, control signalling instructing the RAN node to page a wireless device, the control signalling being indicative of paging escalation. The method comprises transmitting WUS to the wireless device using the WUS group for use in paging escalation.

The present disclosure pertains to the field of wireless communications. The present disclosure relates to methods for Wake Up Signal communication, related radio access network nodes, related core network nodes and related wireless devices.

### BACKGROUND

Energy efficiency is one of the key design requirements for Machine Type Communication, MTC, devices and Narrow-Band Internet-of-things, NB-IoT, devices. Idle channel listening and false wake-ups contribute to energy waste in these types of wireless devices when the wireless devices are listening for paging.

In 3^{rd} Generation Partnership Project, 3GPP, systems Release 15, a wake-up signaling mechanism is introduced to reduce the idle channel listening cost associated with paging. In the wake-up signaling mechanism, a wireless device (such as user equipment, UE) listens to the channel for a Wake Up Signal, WUS, on a pre-configured time and frequency before a paging occasion and proceeds to further decode the control channel and the data channel only if a WUS is detected. In this wake-up signaling mechanism, however, all of the wireless devices listen for the same WUS and if they are configured to have the same DRX-ON configuration, the cost of false wake-ups can become significant.

To reduce the false wake-up cost, a WUS grouping mechanism was introduced in Release 16. Using WUS grouping, the wireless devices, listening to the same paging occasions, are divided into a certain number of groups, where each group needs to only listen for its WUS group or WUS sub-group, leading to a reduced false wake-up probability.

Applying a WUS grouping based on a wireless device identifier, the false wake-up issues can be alleviated. However, it may not be sufficient There is room for further improvements on the WUS mechanism and on alleviating false wake-up issues.

### SUMMARY

Considering that different wireless devices may have different paging probabilities or different services, grouping wireless devices based on different paging probabilities or different services is to be further improved for the purpose of reducing false wake-ups. While the existing WUS grouping may reduce the cost of false wake-ups for wireless devices within a certain cell, the WUS grouping functionality is not optimal for scenarios where the wireless devices move between cells and/or lose coverage in a cell. For example, wireless devices which are not reachable in their last used cell and which are likely to receive paging signals more often, can destroy WUS benefits for the wireless devices monitoring WUS which are in the same tracking area. It is also seen as beneficial to avoid the false wake-up of the other wireless devices, e.g. with the same paging probability group in other neighboring cells(s) (as illustrated in FIG. 1B). Further, it may be envisaged that a wireless device which has moved between cells and/or has lost coverage may only be paged with WUS in its last used cell (e.g. cell where the wireless device was last in the connected mode).

Accordingly, there is a need for radio access network nodes, wireless devices, core network nodes and methods for WUS communication, which mitigate, alleviate or address the shortcomings existing and provide a further reduction of false wake-ups caused by wireless devices which are not reachable in their last used cell, such as wireless devices moving out of the coverage of their last used cell and/or into the coverage of a new cell, such as a neighboring cell of their last used cell.

Disclosed is a method performed by a Radio Access Network, RAN, node for Wake Up Signal, WUS, transmission according to the disclosure. The method comprises broadcasting information indicative of a WUS group for use in paging escalation. The method comprises receiving, from a core network node, control signalling instructing the RAN node to page a wireless device, the control signalling being indicative of paging escalation. The method comprises transmitting a WUS to the wireless device using the WUS group for use in paging escalation.

Further, a radio access network node is provided, the radio access network node comprising a memory circuit, a processor circuit, and a wireless interface, wherein the radio network node is configured to perform any of the methods disclosed herein.

The disclosed RAN node and related method enable a reduction of the magnitude of false wake-ups caused by wireless devices which are not reachable in their last used cells, by defining a WUS group for use in paging escalation. The wake-up signalling using the WUS group for use in paging escalation limits the number of wireless devices woken up for paging due to the wireless devices that have reselected a new cell. For example, the disclosed technique also avoids false wake-up of wireless devices associated with the same WUS group (e.g. WUS paging probability group) in neighbour cells during paging escalation (e.g. illustrated in FIG. 1B).

Disclosed is a method performed by a wireless device, for WUS reception. The method comprises, upon entering a new cell, receiving, from a RAN node of the new cell, information indicative of a WUS group for use in paging escalation. The method comprises monitoring, based on the information received, for WUS in the WUS group indicated by the received information.

A wireless device is provided, the wireless device comprising a memory circuit, a processor circuit, and a wireless interface, wherein the wireless device is configured to perform any of the methods disclosed herein.

It is an advantage of the present disclosure that the disclosed wireless device is not prevented from using WUS during paging escalation, which can take place when losing coverage from last used cell(s) and entering a new cell. It is an advantage of the present disclosure that the cost of false wake-ups related to paging is reduced. The disclosed wireless device may be able to benefit from WUS with a reduced effect of false wake-ups of wireless devices remaining within a cell and in neighbouring cells, leading to an overall reduced cost associated with false wake-ups. It may be appreciated that power consumption due to false wake-ups is also reduced.

Disclosed is a method performed by a core network node, for Wake-Up Signal, WUS, for paging a wireless device (for example, for controlling and/or supporting WUS for paging a wireless device). The method comprises determining paging escalation; and transmitting, to a radio access network, RAN, node of one or more neighbouring cells of a last used cell for the wireless device, control signalling indicative of paging for the wireless device including an indication of paging escalation.

A core network node is provided, the core network node comprising a memory circuit, a processor circuit, and a wireless interface, wherein the core network node is configured to perform any of the methods disclosed herein.

It is an advantage of the present disclosure that the disclosed core network node benefits from paging escalation while enabling a reduced effect of false wake-ups of wireless devices present in one or more cells (e.g. remaining within the last used cell and the neighbouring cells of the last used cell).

### BRIEF DESCRIPTION OF THE DRAWINGS

The above and other features and advantages of the present disclosure will become readily apparent to those skilled in the art by the following detailed description of example embodiments thereof with reference to the attached drawings, in which:

FIG. 1A is a diagram illustrating an example wireless communication system comprising an example network node and an example wireless device according to this disclosure,

FIG. 1B is a diagram illustrating an example scenario of one or more example challenges,

FIG. 1C is a diagram illustrating an example scenario according to this disclosure,

FIG. 2 is a flow-chart illustrating an example method, performed by a radio access network node of a wireless communication system, for WUS transmission according to this disclosure,

FIG. 3 is a flow-chart illustrating an example method, performed by a wireless device, for WUS reception according to this disclosure,

FIG. 4 is a flow-chart illustrating an example method, performed in a core network node, for Wake-Up Signal, WUS, for paging a wireless device according to this disclosure,

FIG. 5 is a block diagram illustrating an example radio access network node according to this disclosure,

FIG. 6 is a block diagram illustrating an example wireless device according to this disclosure,

FIG. 7 is a block diagram illustrating an example core network node according to this disclosure, and

FIG. 8 is a signalling diagram illustrating an example embodiment according to this disclosure.

### DETAILED DESCRIPTION

Various example embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

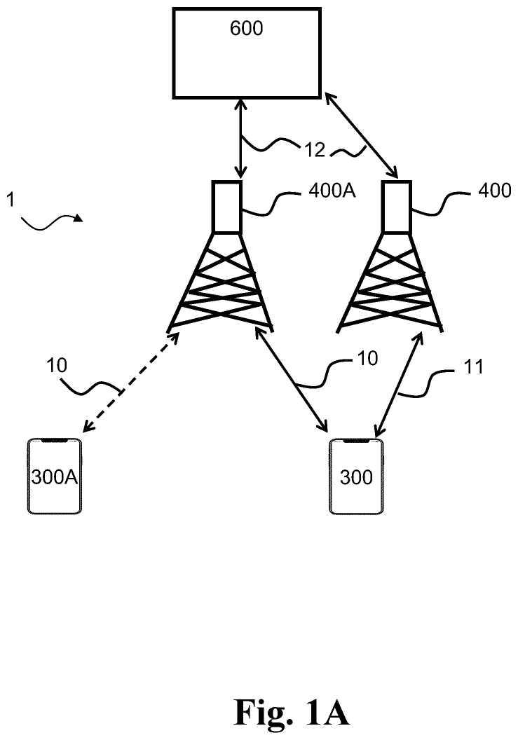

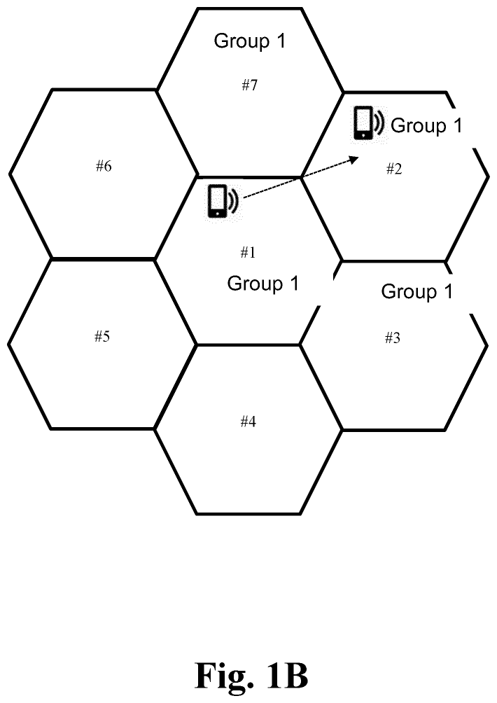

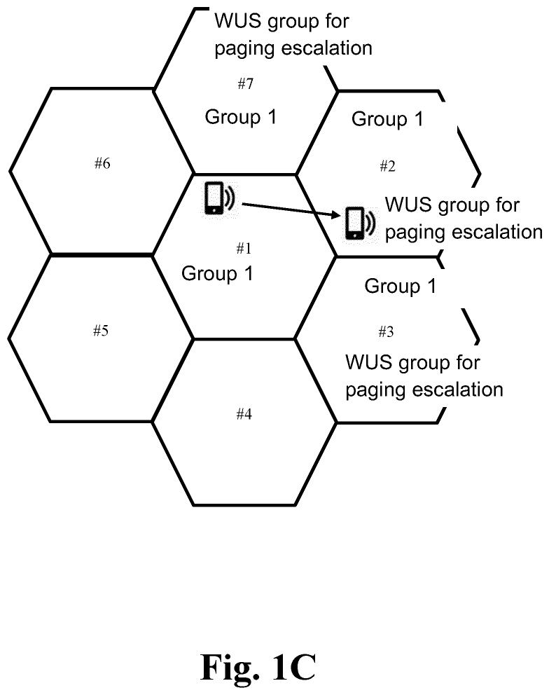

FIG. 1A is a diagram illustrating an example wireless communication system 1 comprising an example core network node 600, an example Radio Access Network, RAN, node 400 and an example wireless device 300 according to this disclosure.

As discussed in detail herein, the present disclosure relates to a wireless communication system 1 comprising a cellular system, for example, a 3GPP wireless communication system.

The wireless communication system 1 comprises optionally an additional wireless device 300A.

A RAN node disclosed herein refers to a radio access network node operating in the radio access network, such as a base station, an evolved Node B, eNB, and/or a Next Generation Node B, gNB. In one or more embodiments, RAN node is a functional unit which may be distributed in several physical units.

A wireless device disclosed herein may refer to a mobile device and/or a user equipment, UE. For example, the wireless device may be an MTC device and/or an IoT device.

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME.

The wireless communication system 1 described herein may comprise one or more wireless devices 300, 300A, and/or one or more RAN nodes 400, such as one or more of: a base station, an eNB, a gNB and/or an access point.

The wireless device 300 may be configured to communicate with the RAN node 400 via a wireless link (or radio access link) 11.

The wireless device 300 may be configured to communicate with the RAN node 400A via a wireless link (or radio access link) 10.

The RAN node 400, 400A may be configured to communicate with the CN node 600 via a link 12 (which may be a wired and/or wireless link).

The wireless communication system 1 comprises, for example, a RAN node 400A of the last used cell of the wireless device 300, and a RAN node 400 of a neighbouring cell of the last used cell. The wireless device 300 may, for example, not be reachable by the RAN node 400A (due to mobility and/or due to poor coverage) in its last used cells, such as cell #1 controlled by RAN node 400A. The wireless device 300 may for example become reachable in a new cell, such as a neighbouring cell, such as cell #2 controlled by RAN node 400.

A Wake Up Signal, WUS (e.g. Group WUS) refers to a signal that may be used to wake up a group of wireless devices (referred to as WUS group). A group (e.g. WUS group) refers to a group of one or more wireless devices listening to the same signal, e.g. the same WUS (e.g. group WUS).

The wireless device 300 may be woken up using a group Wake Up Signal, GWUS. A group WUS mentioned herein may also be referred to as a WUS targeting one or more wireless devices (which form a WUS group) that may be woken up with a WUS transmission for that WUS group. The UE of the WUS group may then be paged with a paging message. A WUS comprises for example group WUS (GWUS) (e.g. of Release 16). A group WUS may be configured differently in different cells in terms of resources (and WUS sequences). It may be appreciated that information regarding WUS and WUS groups is broadcasted so that wireless devices that belong to one WUS group are capable of monitoring the same resources for WUS when the wireless devices are in the same cell.

The wireless device 300 may monitor for a Wake Up Signal, WUS, using a WUS group. The WUS may be transmitted to target the WUS group. A WUS group mentioned herein may also be referred to as a group of one or more wireless devices that may be woken up with a WUS transmission and/or may be paged with a paging message.

FIG. 1B is a diagram illustrating an example scenario where this disclosure is not applied. A method of determining WUS grouping may be done in several steps. WUS grouping may be seen as the grouping of UEs to be woken up together using with a WUS transmission (e.g. in a multicast transmission targeted at a plurality of UEs forming the WUS group). In a WUS grouping mechanism, a RAN node defines the WUS group while the wireless device determines independently the WUS group based on a combination of signalled information and predefined rules negotiated with the CN node (e.g. the MME). Optionally, the CN node is capable of (independently from the other entities) determining information related to a WUS group.

Information related to paging probability information is available at the CN node, e.g. the MME. This information (including for example paging probability (NAS_{prob})) may be negotiated between the wireless device and CN node (e.g. MME via NAS signalling). A paging probability configuration, broadcasted via system information, may carry two types of information: one or more paging probability thresholds, and a number of WUS groups including one or more WUS groups for each range of the probability ranges defined by the probability thresholds. This can allow assignment of different numbers of WUS groups to specific probability ranges. Since different gaps, between WUS and DRX-ON, can be available depending on the receiver architecture, the grouping may apply to each gap type. For service-based grouping, the number of WUS groups is configured via system information broadcasted for each gap type. For example, once the wireless device (e.g. UE) has determined the list of WUS groups corresponding to its paging probability (NAS_{prob}) or the wireless device identifier (e.g. UE ID) based set, then the wireless device needs to select one WUS group from this set (for example in order to distribute the wireless devices evenly amongst the WUS groups in the set).

With group WUS (GWUS), the RAN node (e.g. eNB) can configure one or more group WUS resources via RRC (Radio Resource Control) signalling. For example, for NB-IoT, the RAN (such as Evolved Universal Terrestrial Access Network, E-UTRAN) may configure up to 2 WUS resources (numbered 0 and 1). For wireless devices with Bandwidth-reduced Low-complexity (BL), and wireless devices with enhanced coverage, the RAN (e.g. E-UTRAN) may configure up to 4 WUS resources (for example, numbered 0, 1, 2, and 3). When group WUS is configured, at least one WUS resource may be configured. A wireless device can be configured to monitor up to two WUS sequences in a WUS resource, for a group WUS and, if configured, for a common WUS (for example, needed if more than one group is needed to be woken-up by an eNB).

While the existing WUS grouping reduces the cost of false wake-ups for UEs within a certain cell, the WUS grouping functionality is not optimal for scenarios where the wireless devices are not reachable, by the RAN node, in their last used cells, for example when moving between cells and/or out of coverage from their last used cells. For example, a wireless device, that moves between the cells within the Tracking Area (or Tracking Areas belonging to a TA list) and receives paging very often, can destroy WUS benefits for many, possibly all, the WUS UEs in the Tracking Area Identifier list, TAI LIST of the wireless device which is moving.

In Release 15, this is addressed by the CN node, e.g. MME, including “last used cell ID” in the S1 paging to the RAN nodes (so that the RAN node can determine if the last used RAN node associated with the S1 paging received is or is not itself) and the wireless devices are modified so that they do not use WUS in any cell other than the last used cell. This is to be improved as it prevents the use of WUS in case of paging escalation, and results in false wake-ups for the wireless devices within the last used cell and in new cells, such as neighboring cells of the last used cell. This also prevents benefits of using WUS for the wireless device which moves out of the last used cell and/or experiences poor coverage from the last used cell.

FIG. 1B shows an example scenario where this challenging situation is illustrated. In other words, FIG. 1B illustrates the UE group paging and the paging escalation mechanism, and related challenges.

In an example, when the wireless device belongs to Group 1 and is expected to be statically located in cell #1, then the network typically pages the wireless device in the last connected cell, in this case, cell #1. When the wireless device becomes unreachable in its last used cell, which is cell #1 (for example, when the wireless device has moved (during idle mode) to cell #2), the network (e.g. the RAN node, and/or the CN node, e.g. MME) is not aware of the move of the wireless device when cell #2 is part of the same Tracking Area. The first paging attempt in the last connected or last used cell (cell #1) fails. The network then performs a paging escalation by also paging the wireless device in the neighbor cell(s): cell #2, cell #3, and cell #7 in FIG. 1B. As a result, the wireless devices belonging to Group 1 in these multiple cells (cell #2, cell #3, and cell #7) unnecessarily wake up. This may be referred to as a false wake-up of the one or more wireless devices belonging to Group 1 in the neighboring cells (cell #2, cell #3, and cell #7) of a last used cell (cell #1).

Paging escalation may be seen as an escalated paging of one or more wireless devices by requesting paging to be performed in more cells than the last used cell(s), such as in the neighboring cells of the last used cell(s), in an attempt to page one or more wireless devices which are not reachable by the CN node and/or the RAN node in their last used cells. Stated differently, the CN node may perform a paging escalation by requesting to page the wireless device over a larger (e.g. wider) group of cells than the last used cells, such as a major part, possibly all, of the cells in a Tracking Area (or tracking areas in a tracking area list) where the wireless device has camped (or presumably camping after once having attached to the RAN node) or attached. For example, a paging escalation may occur when the one or more wireless devices have left their last used cells (e.g. their last used cells as declared at the CN node). For example, a paging escalation may occur when the one or more wireless devices experience a channel quality from their last used cells that is below a threshold (such as a threshold based on channel measurements, such as Reference Signal Received Power, RSRP, such as a poor channel quality, such as loss of coverage due to poor channel quality). For example, a paging escalation may occur because a wireless device fails to detect the WUS due to decoding error of the WUS sequence transmitted by the RAN node.

When a wireless device has left its last used cell(s) (e.g. their last used cells as declared at the CN node) or a wireless device experiences a channel quality from their last used cells that is below a threshold, the wireless device cannot respond to a paging message initiated by the CN node and transmitted via the RAN node of its last used cell(s). When the wireless device does not respond, the CN node does not receive a response to the paging message and can then trigger a paging escalation. The CN node can then indicate to the RAN node the paging escalation by sending a paging message to the RAN nodes of neighboring cells of the last used cell(s). Each RAN node can detect the paging escalation by determining that the last used cell identified in the paging message from CN node is different from its own cell identifier.

Stated differently, paging escalation may be used for paging in more cells when the wireless device has moved out of the coverage of the last cell that the wireless device was connected in. For example, during paging escalation, a RAN node of a neighboring cell of the last used cell can perform paging using a WUS group for use in paging escalation which may be based on another temporary paging probability for finding a specific UE, that is moving in between cells.

It may be appreciated that the wireless device is the node that is capable of detecting that the wireless device has left its last used cell(s) and of concluding, based on the detection, that the wireless device is likely to be paged in a new cell, such as a neighboring cell of its last used cell(s), which is caused by a paging escalation from the network. For example, the wireless device can determine that the cell ID has been changed and then can infer that there may be paging escalation triggered by the network. It may be appreciated that the CN node (such as the MME) can detect that the wireless device is no longer reachable in the last used cell(s) when the CN node does not receive a paging response (e.g. due to the wireless device having really left the last used cell or due to the wireless device still being in the same cell but experiencing a poor coverage from the last used cell).

This disclosure enables a reduction of false wake-ups of stationary or low mobility wireless devices that can get affected by paging escalation triggered by a wireless device which is not reachable (for example, due to relatively higher mobility and/or poor coverage from the last used cell).

FIG. 1C is a diagram illustrating an example scenario according to this disclosure. This disclosure provides, in one or more embodiments, a WUS mechanism for paging escalation by defining a WUS group for use in paging escalation. This supports mobility and reduces false wake-up of the wireless devices that have not been moving between different cells.

In an example, the wireless device is originally in cell #1 and the wireless device has been assigned to Group 1 in cell #1.

When the wireless device is not reachable in cell #1 (for example, when the wireless device has moved to a new cell and the network (CN node, and/or RAN node) cannot find the UE in the last known cell), the CN node (e.g. MME) initiates paging escalation: paging of the wireless device in the neighbouring cell(s) of cell #1 and indicates to the RAN node the paging escalation (for example, inferring that the wireless device is not reachable, or inferring that the wireless device may belong to a mobility group). When the RAN nodes of the neighbouring cell(s) (e.g. cell #2, cell #3 and cell #7) receive the paging escalation indication, the RAN nodes start to page the wireless device using the WUS group for use in paging escalation, shown as “WUS group for paging escalation” in FIG. 1B. Unlike the scenario described in FIG. 1B, the wireless devices of Group 1 in cell #2, #3, #7 remain undisturbed by the paging escalation and “sleep” through the paging escalation. Hence, there is no false-wake-up experienced by the wireless devices of Group 1 in cells #2, #3, #7. It may be appreciated that there is no false-wake-up experienced by the wireless devices which are part of any group different from “WUS group for paging escalation”. The one or more wireless devices of the “WUS group for paging escalation” in cells #2, #3, #7 can monitor for WUS, and can wake up based on the received WUS from the RAN node of their respective cells, for receiving paging.

In this example, the wireless device which was not reachable in cell #1 is now reachable in cell #2. At some point, under RRC Idle mode, the wireless device may, switch WUS group according to a paging probability negotiated with the CN node.

A WUS group for use in paging escalation disclosed herein refers to a WUS group for use when it is expected and/or indicated, e.g. by a CN node, that paging escalation is performed, for example in an attempt to reach a wireless device that is not reachable in its last used cells. It may be appreciated that the WUS group for use in paging escalation is used at the RAN node and/or at the wireless device while the paging escalation may be detected and performed at the CN node and/or the RAN node. The WUS group for use in paging escalation may be seen as a WUS group for temporary use during paging escalation. In one or more embodiments, the WUS group for use in paging escalation may be interpreted as a temporary WUS group. In one or more embodiments, the WUS group for use in paging escalation may be interpreted as a mobility WUS group (such as a temporary mobility WUS group), which may be dedicated to wireless devices which are no longer camped in their last used cells.

Last used cells may be seen as cells where the wireless device has registered prior to paging escalation. For example, last used cells associated with the wireless device may be seen as last connected cells associated with the wireless device. For example, last used cells may be seen as cells that the wireless device has had an established RRC connection, (e.g. the wireless device has been in RRC connected mode). The wireless device for example has been handed over from one cell to another cell being in RRC connected mode. The wireless device for example is only moving in between two cells back and forth and having establishment of connection in each of them independently. For example, last used cells may be seen as last cells where the wireless device has camped, and/or attached with the RAN node. For example, last used cells include several cells where the wireless device has been in connected mode and/or in idle mode. For example, last used cells include a number of cells in the neighbourhood of the last used cell so as to reach a larger area than the area where the WUS groups which are not used in paging escalation (such as “normal” WUS groups) are used. For example, the last used cells include the last serving cell.

It may be appreciated that in one or more embodiments, paging escalation is performed, for example in attempt to reach a wireless device that is not reachable in at least one of its last used cells, such as the last used cell.

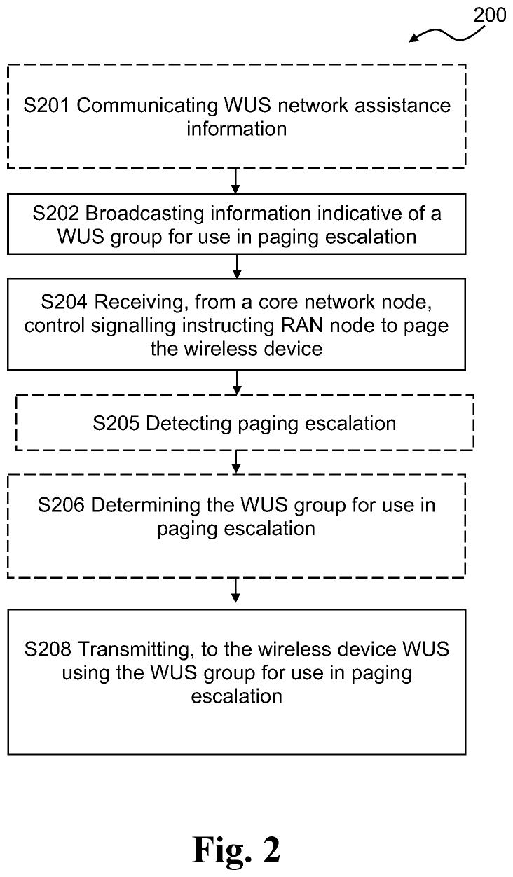

FIG. 2 shows a flow diagram of an example method 200 performed by a RAN node for Wake Up Signal, WUS, transmission according to the disclosure. The method 200 is performed by a RAN node, such as the RAN node disclosed herein, such as RAN node 400 of FIGS. 1A, 6 and 8.

The method 200 comprises broadcasting S202 information indicative of a WUS group for use in paging escalation. For example, broadcasting S202 the information indicative of the WUS group for use in paging escalation comprises transmitting, to a plurality of wireless devices, the information indicative of the WUS group for use in paging escalation. In one or more example methods, the information is broadcasted via system information. For example, the information is broadcasted via a system information block, SIB. For example, the information may comprise information indicative of Group WUS configuration (for example, as illustrated in TS 36.331). For example, the broadcasted information can include a new paging probability threshold for a group of wireless devices forming part of the WUS group for use in paging escalation. For example, the RAN node can broadcast paging probability=100, which corresponds to the WUS group for use in paging escalation.

Stated differently, the RAN node may encounter, confront, and/or detect a paging escalation and the WUS group for use in paging escalation may be seen as a WUS group for use when encountering, confronting, and/or detecting paging escalation. It may be envisaged that the RAN node may define, as the WUS group for use in paging escalation, at least a temporary WUS group that is for a group of UEs that cannot be found in the last known cell (e.g. temporary mobility group). More temporary groups can be defined in which each temporary group corresponds to a paging probability.

In one or more example methods, the information comprises a WUS group identifier of the WUS group for use in paging escalation. For example, the RAN node can explicitly broadcast the WUS group identifier (for example, the group ID of the WUS group for use in paging escalation, such as a group ID of a temporary WUS group for paging escalation). This allows the wireless device to obtain the WUS group for use in paging escalation in neighbouring cells of the last used cells, when the wireless device becomes unreachable in its last used cells.

Optionally, the information indicative of the WUS group for use in paging escalation may be indicative of a plurality of WUS groups for use in paging escalation. In other words, there may be a plurality of WUS groups for use in paging escalation to be used by the RAN node and/or the wireless device disclosed herein. It may be envisaged that there may be more than one WUS group that is used for wireless devices that are mobile. For example, when there are many wireless devices in the network that are mobile, and some of the wireless devices are more frequently paged than others, the wireless devices may be associated with or distributed across different WUS groups for use in paging escalation.

In one or more example methods, the information comprises a paging probability configuration for the WUS group for use in paging escalation. For example, the paging probability configuration may include information indicative of a paging probability threshold.

In some embodiments, information indicative of available WUS groups is broadcasted and the UE has previously obtained information about which WUS group is the WUS group for use in paging escalation. The information may for example be pre-configured, such as standardised. For example, there may be a rule providing that the WUS group corresponding to the highest paging probability should always be the WUS group for use in paging escalation. Hence, in some embodiments the UE determines the WUS group for use in paging escalation based on the broadcasted information.

The method 200 comprises receiving S204, from a core network node, control signalling instructing the RAN node to page a wireless device, the control signalling being indicative of paging escalation. For example, the RAN node receives, from the CN node, a paging message (such as S1-AP (S1 Application protocol) paging message) targeted at the wireless device and indicating that a paging escalation is triggered by the CN node. The S1-AP paging message includes for example a paging probability and indication to use of the WUS group for use in paging escalation. In other words, the CN node, such as MME, indicates to the RAN node that the CN node wants to page the wireless device as part of a paging escalation. For example, the control signalling instructing the RAN node to page the wireless device comprises WUS network assistance information. In one or more example methods, the method comprises detecting S205, based on the control signalling received, the paging escalation. In other words, the RAN node detects that this paging is also performed in other cells. For example, detecting S205 based on the control signalling received in S204, the paging escalation may comprise determining that a last used cell indicated in the control signalling received in S204 is different from the cell identity or identifier of the RAN node receiving the control signalling. In one or more example methods, detecting S205 the paging escalation is based on that the one or more wireless devices are not reachable in their last used cells. In one or more example methods, detecting S205 the paging escalation is based on that the wireless device has left their last used cells. For example, when a wireless device has left its last used cell(s) (e.g. their last used cells as declared at the CN node), the wireless device cannot receive and cannot respond to a paging message initiated by the CN node and transmitted to the wireless device via the RAN node of its last used cell(s). When the wireless device does not respond, the CN node does not receive a response to the paging message and can then trigger a paging escalation. The CN node can then indicate to the RAN node of the neighboring cells of the last used cell(s) (such as the RAN node of method 200) the paging escalation by sending the control signalling instructing the RAN node to page a wireless device to the RAN node as part of the RAN nodes of neighboring cells of the last used cell(s). The RAN node can detect the paging escalation by determining that the last used cell identified in the the control signalling from CN node is different from its own cell identifier. In other words, the RAN node can detect the paging escalation based on the received control signalling in S204 and based on that the wireless device is not reachable in its last used cell(s), e.g. the wireless device has left their last used cells.

In one or more example methods, detecting S205 the paging escalation is based on that the wireless device experiences a channel quality from their last used cells that is below a threshold. For example, the wireless device may detect that the RSRP measurements are below an acceptable threshold for remaining camped/attached to the last used cell(s). For example, the threshold may be defined to detect when the wireless device is not allowed to camp on a cell (such as a last used cell(s)) and therefore lose coverage from the network (e.g. on any cells). A paging escalation may then be triggered by the network when the wireless device is paged but the wireless device does not provide any response. Hence, RAN node (as instructed by MME) is, for example, to send paging again (so called paging escalation).

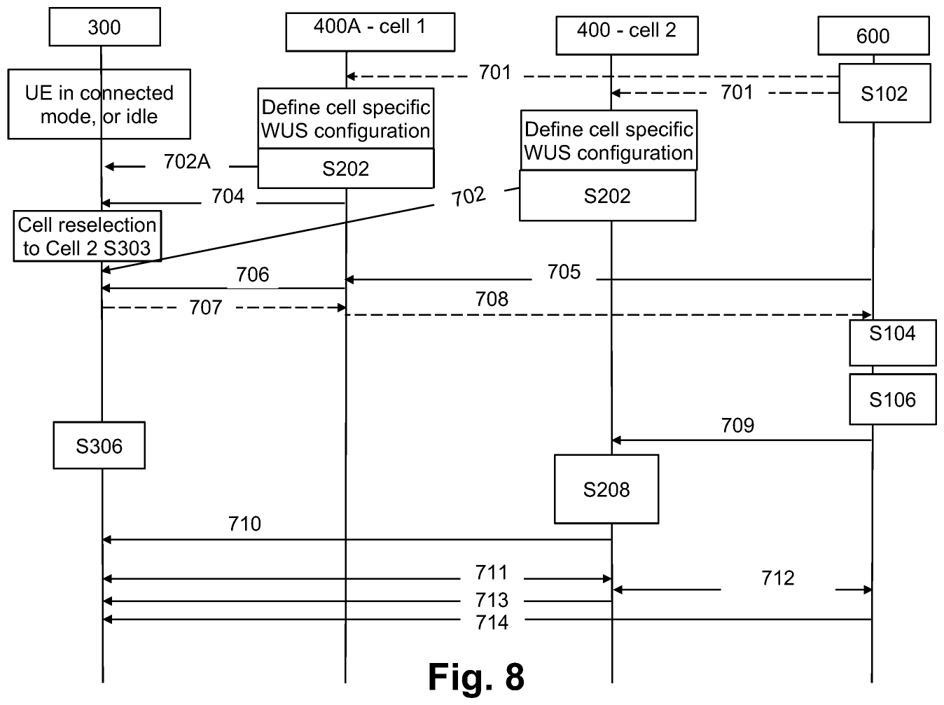

In one or more example methods, detecting S205 the paging escalation is based on that the wireless device experiences a channel quality from a neighbouring cell of the last used cell(s) that is better (e.g. higher) than the channel quality of the last used cell(s). For example, the wireless device changes cell when finding a cell with better channel quality than the channel quality of the last used cell(s). Channel quality may be measured by Signal to Noise Ratio, SNR, and/or RSRP. For example, when a wireless device experience a channel quality from their last used cells that is below a threshold, the wireless device cannot receive and cannot respond to a paging message initiated by the CN node and transmitted to the wireless device via the RAN node of its last used cell(s) (as illustrated in messages 705, 706, 707, 708 of FIG. 8). When the wireless device does not respond, the CN node does not receive a response to the paging message and can then trigger a paging escalation. The CN node can then indicate to the RAN node of the neighboring cells of the last used cell(s) the paging escalation by sending the control signalling instructing the RAN node to page a wireless device to the RAN node as part of the RAN nodes of neighboring cells of the last used cell(s). The RAN node can detect the paging escalation by determining that the last used cell identified in the the control signalling from CN node is different from its own cell identifier. In other words, the RAN node can detect the paging escalation based on the received control signalling in S204 and based on that the wireless device is not reachable in its last used cell(s), e.g. based on that the wireless device experiences a channel quality from their last used cells that is below a threshold.

In one or more example methods, the method 200 comprises communicating S201, between the core network node and the RAN node, WUS network assistance information (for example, prior to paging escalation, for example when the cell-specific WUS configuration is defined or obtained). For example, the RAN node receives configuration information, as WUS network assistance information. For example the configuration information comprises configuration regarding what WUS group the wireless device belongs to amongst one or more WUS groups including the WUS group for use in paging escalation. For example, WUS network assistance information may enable applying a predetermined set of rules to determine the WUS group for use in paging escalation. For example, the WUS network assistance Information may be used by the RAN node to help determine the WUS group used when paging the wireless device. For example, the WUS network assistance information may comprise paging probability information. For example, the paging probability information provides a metric on the probability of a wireless device receiving a paging message based on, e.g., statistical information. Optionally, the configuration of WUS groups may be defined by specification and/or by management of the network (Operations, Administration and Maintenance, OAM entity). The CN node stores the WUS Assistance Information parameter in a context, such as Mobility Management, MM, context and provides it to the RAN node when paging the wireless device. For example, for each wireless device attached to an MME, specific mobility management and evolved packet system context information form part of the MM context stored at the MME. WUS assistance information may be used interchangeably with WUS network assistance information in one or more embodiments.

In some embodiments, the configuration information is standardised and preconfigured (such as hardcoded information regarding which WUS group the UE should use during paging escalation). For example, a RAN node can read information about WUS groups and when the RAN node detects a paging escalation, the RAN node is preconfigured to select the WUS group for paging escalation, e.g. the WUS group corresponding to the highest paging probability, even if the wireless device normally belongs to another group. In this case the only change to the wireless device is that it is aware of this preconfigured rule.

The information indicative of available WUS groups (e.g. the information received in S202) may be generated by the RAN node based on the WUS assistance information

In one or more example methods, the method 200 comprises determining S206, based on the WUS network assistance information, the WUS group for use in paging escalation. For example, determining S206, based on the WUS network assistance information, the WUS group for use in paging escalation comprises applying a predetermined set of rules, for example obtained via control signalling. In one or more example methods, the determined WUS group for use in paging escalation comprises a dedicated WUS group. For example, the dedicated WUS group may be a WUS group dedicated to paging escalation, such as WUS group dedicated to (that is only for use by) wireless devices which are no longer in their last used cells and/or wireless devices which have experienced poor channel quality from their last used cells. For example, the dedicated WUS group may be a WUS group dedicated for mobile UEs, such as UEs in movement away from their last used cells, such as UEs moving out of coverage of their last used cells. For example, the WUS group for use in paging escalation may be seen as a dedicated temporary WUS group in a cell, e.g. group ID X. In one or more embodiments, the WUS group for use in paging escalation may be configured per cell and/or per tracking area (such that all cells within the same tracking area, TA, has the same WUS group ID for use in paging escalation, such as the same temporary WUS group). In one or more example methods, the determined WUS group for use in paging escalation comprises a WUS group associated with a predetermined paging probability and/or a pre-existing WUS group. For example, the WUS group for use in paging escalation comprises a preconfigured WUS group, e.g. predetermined WUS group. For example, the WUS group for use in paging escalation comprises a WUS group for legacy, such as of Release 15, which in the cell of the RAN node is used for paging escalation. For example, the WUS group for use in paging escalation may be combined with any existing WUS group. Optionally, the determined WUS group for use in paging escalation comprises a WUS group associated with the highest paging probability (because a legacy wireless device with highest paging probability is likely not to be severely affected by more fake wake-ups).

In one or more example embodiments, the WUS group for use in paging escalation may (based on the set of rules applied) be the same as the WUS group used prior to cell-reselection by the wireless device.

In one or more example embodiments, the WUS group for use in paging escalation may be different from the WUS group used prior to cell-reselection by the wireless device.

The method 200 comprises transmitting S208 WUS to the wireless device using the WUS group for use in paging escalation. The WUS occupies time and frequency resources, such as WUS resources allocated to WUS transmission. A wireless device (such as user equipment, UE) listens to the channel for a Wake Up Signal, WUS, on a pre-configured time and frequency before a paging occasion and proceeds to further decode the control channel and the data channel only if a WUS is detected. A WUS can be transmitted using certain modulation with/without coding by RAN node.

In one or more example methods, WUS is in the form of a signal. In some embodiments, WUS can be in the form of a channel. The signal can be generated using a sequence generator (e.g. m-sequence, a Zadoff-Chu-sequence) and possibly using a mapping known to the wireless device. The WUS can be in the form of a Physical Downlink Control Channel (PDCCH). The WUS can be dedicatedly used for power saving purpose. For example, the RAN node can transmit WUS to the wireless device using WUS resources allocated to the GWUS during paging escalation. For example, the RAN node can transmit WUS to the wireless device using WUS resources allocated to GWUS, and using the WUS group for use in paging escalation. For example, the GWUS may be targeted at the WUS group for use in paging escalation. It may be appreciated that each WUS group has sequences and resources configured by SIB, so that the UE knows how to detect the WUS targeted to its WUS group. For example, once the RAN node receives the control signalling of S204 from the CN node, the RAN node transmits the WUS to wireless devices listening the WUS for the WUS group of paging escalation (such as a temporary WUS group). For example, the WUS wakes up the wireless device in advance of and/or in preparation of the paging message. The method 200 may comprise transmitting, to the wireless device, a paging message following the WUS of S208 transmitted using the WUS group for use in paging escalation

In one or more example embodiments, the RAN node establishes an RRC connection with the wireless device paged using the WUS group for use in paging escalation and may release the wireless device to a power-saving mode (such as Idle mode, such as RRC Idle and/or RRC Inactive). In one or more example embodiments, the RAN node (when sending WUS and paging the wireless device) and the wireless device (to receive the paging and WUS) revert to using WUS groups which are not for use in paging escalation (such as for conventional WUS-based paging, such as WUS groups for wireless devices which are still in their last connected cell).

In one or more example embodiments, WUS groups which are not for use in paging escalation (such as for conventional WUS-based paging, such as the WUS group with the highest paging probability) may (based on the set of rules applied) be the same as the WUS group for use in paging escalation.

In one or more example embodiments, WUS groups which are not for use in paging escalation (such as for conventional WUS-based paging) may be different from the WUS group used prior to cell-reselection by the wireless device.

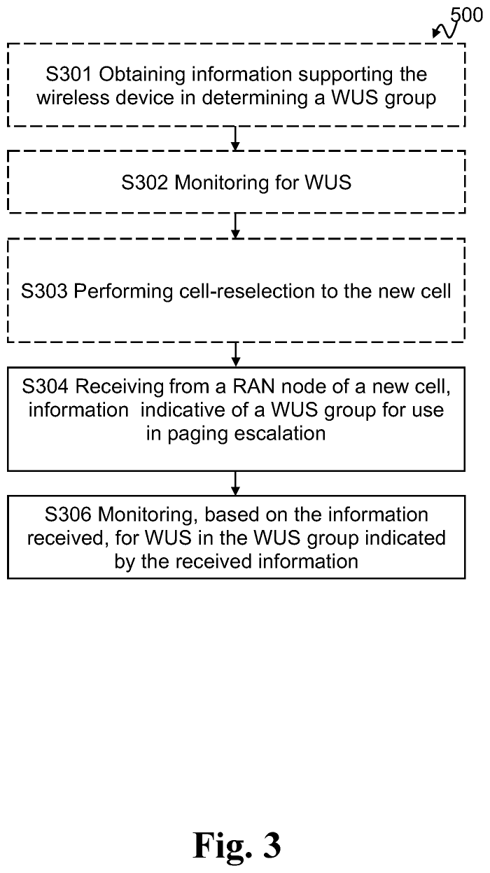

FIG. 3 shows a flow-chart illustrating an example method 500, performed by a wireless device, for WUS reception according to this disclosure. The method 500 is performed by the wireless device disclosed herein, such as wireless device 300 of FIGS. 1A, 6, and 8.

In one or more example methods, the method 500 comprises obtaining S301 information supporting the wireless device in determining a WUS group, for example including the WUS group for use in paging escalation, and/or other WUS groups. In some embodiments, the wireless device determines, for a given cell, WUS groups including the WUS group for use in paging escalation, based on the information obtained in S301, for example for use when paging wireless devices which have left their last used cells. For example, the wireless device receives, from the CN node, the information indicative of a set of rules to apply for determining the WUS group for use in paging escalation. For example, the wireless device retrieves the information from the memory of the wireless device and derives the WUS group from received information, by applying retrieved set of rules to determine the WUS group. For example, the information may be indicative of a paging probability provided by the core network (e.g. in TS24.401 section 4.3.21.4.). For example, the wireless device may in the Attach Request message to the CN node provide its capability to support WUS Assistance Information. If WUS Assistance Information is supported, then the wireless device in the Attach Request or Tracking Area Update message may provide the additional UE paging probability information. The CN node, e.g. MME, may use the paging probability provided by the wireless device, local configuration and/or previous statistical information for the wireless device when determining the WUS Assistance Information. When the wireless device supports WUS Assistance Information, the CN node may assign WUS Assistance Information to the wireless device, even when the wireless device has not provided the additional UE paging probability information. When the CN node has determined WUS Assistance Information for the wireless device, the CN node provides it to the wireless device in every Attach Accept and/or Tracking Area Update message. The CN node stores the WUS Assistance Information parameter in a context, such as MM context and provides it to the RAN node when paging the wireless device.

In some embodiments, information indicative of available WUS groups is broadcasted and the UE has previously obtained information about which WUS group is the WUS group for use in paging escalation. The information may for example be pre-configured, such as standardised. For example, there may be a rule saying that the WUS group corresponding to the highest paging probability should always be the WUS group for use in paging escalation. Hence, in some embodiments the UE determines the WUS group for use in paging escalation based on the broadcasted information.

In one or more example methods, the method 500 comprises monitoring S302 for WUS in a first WUS group based on the information obtained in S301. In other words, the wireless device receives a Wake Up Signal on the WUS resources configured for the first group WUS while attached/camping in its last used cell and tries to identify a WUS sequence of the first group WUS. For example, the wireless device can be configured to monitor one or more WUS sequences in a WUS resource, for a group WUS. For example the first WUS group is part of the WUS group for wireless devices which are camped and/or attached to their last used cell (e.g. legacy WUS groups). It may be appreciated that the first WUS group is a WUS group prior to cell-reselection, e.g. when the wireless device is still reachable in its last used cell(s).

The first WUS group may be different from the WUS group for use in paging escalation in some embodiments. The first WUS group may be determined (by applying the set of rules obtained in e.g. S301) to be the same as the WUS group for use in paging escalation in some embodiments.

In one or more example methods, the method 500 comprises performing S303 a cell-reselection to a new cell. For example the new cell may be a neighbouring cell of a last used cell. For example, the cell-reselection may occur when the UE measurements indicate the neighbour cell has better signal strength (RSRP) than the last used cell. For example, the wireless device performs cell-reselection to a neighbouring cell based on cell-reselection criteria defined in TS 36.304.

The method 500 comprises upon entering a new cell, receiving S304, from a RAN node of the new cell, information indicative of a WUS group for use in paging escalation. The information indicative of the WUS group for use in paging escalation may only be received by the wireless device when the wireless device has not received it before, e.g. earlier. For example, the wireless device has detected a new cell, different from the last used cell(s). The RAN node is of the new cell. For example, the wireless device entering a new cell receives the information indicative of the WUS group for use in paging escalation upon cell-reselection. The new cell may then be seen as a selected cell or reselected cell after cell-reselection is completed. For example, the information indicative of a WUS group for use in paging escalation may be included in system information, such as SIB. For example, a UE enters a new cell (different from the last used cell), the UE does not have to receive the SIB again when the UE already has the SIB information, the UE just has to reselect the WUS group for use in paging escalation, based on received information. For example, the UE might have been in the newly entered cell before. As illustrated in TS 36.331, 5.2.2.4, when the UE in RRC_IDLE enters a cell for which the UE does not have stored a valid version of the system information required in RRC_IDLE (as defined in 5.2.2.3), the UE acquires, using the system information acquisition procedure (as defined in 5.2.3), the system information required in RRC_IDLE (as defined in 5.2.2.3). In other words, the wireless device receives information which allows the wireless devices to temporarily changes from its UE WUS group (e.g. based on paging probability) to the WUS group for use in paging escalation.

The information indicative of a WUS group for use in paging escalation may be broadcasted by the RAN node.

In one or more example methods, the information indicative of the WUS group for use in paging escalation is received via system information (such as a system information block, SIB). For example the wireless device can determine, based on the SIB and a rule (and/or a set of rules) in the standard specification, the WUS group for use in paging escalation. A rule may indicate e.g. if the wireless device has left a last used cell, the wireless device is to always use the WUS group corresponding to a predetermined paging probability. A rule may indicate e.g. if the wireless device has left a last used cell, the wireless device is to always use the WUS group corresponding to the highest paging probability.

In some embodiments, the information indicative of the WUS group is standardised and preconfigured (such as hardcoded information regarding which WUS group the UE should use during paging escalation). For example, a wireless device can read the information about WUS groups and when out of coverage of the last used cell(s), the wireless device is preconfigured to select the WUS group for paging escalation, e.g. the WUS group corresponding to the highest paging probability, even if the wireless device normally belongs to another group. In this case, the change to the wireless device is that it is aware of this preconfigured rule. For example, there may be a rule providing that the WUS group corresponding to the highest paging probability should always be the WUS group for use in paging escalation. Hence, in some embodiments the UE determines the WUS group for use in paging escalation based on the broadcasted information. In one or more example methods, the information indicative of the WUS group for use in paging escalation comprises a WUS group identifier of the WUS group for use in paging escalation. For example the information may indicate a dedicated WUS group for use in paging escalation. In one or more example methods, the information indicative of the WUS group for use in paging escalation comprises a paging probability configuration for the WUS group for use in paging escalation. A rule may indicate e.g. if the wireless device has left a last used cell, the wireless device is to always use the WUS group corresponding to the highest paging probability.

The method 500 comprises monitoring S306, based on the information received, for WUS in the WUS group indicated by the received information. The wireless device monitors based on the information received, for WUS in the WUS group for use in paging escalation. In other words, the wireless device is capable of determining the WUS group for use in paging escalation and monitors the channel for WUS targeted for the WUS group. For example, the wireless device monitors the channel (e.g. monitors the time and frequency resources where WUS may be transmitted by the RAN node) for WUS using the WUS group for paging escalation, and wakes up accordingly in preparation of paging. In one or more example methods, the method 500 comprises receiving, from the RAN node of the entered cell (e.g. the reselected cell), the WUS using the WUS group for use in paging escalation and the paging message. For example, the wireless device has successfully been paged using WUS group for use in paging escalation (for example using temporarily for this first paging in the reselected cell the WUS group for use in paging escalation). The “last used cell” prior to cell-reselection can then be changed to the current cell at the CN node. The wireless device can then switch back to the legacy UE WUS group (based on paging probability and/or based on a wireless device identifier, e.g. a UE ID).

In one or more example methods, the method comprises establishing a RRC connection with the RAN node of the entered cell (e.g. the re-selected cell). In one or more example methods, the method comprises entering a power saving mode (e.g. RRC Idle) and determining, amongst a first WUS group set, the first WUS group for monitoring paging. In one or more example embodiments, the wireless device establishes an RRC connection with the RAN node of the reselected cell. For example, the RAN node may release the wireless device to a power-saving mode (such as Idle mode, such as RRC Idle and/or RRC Inactive). In one or more example embodiments, the RAN node (when sending WUS and paging the wireless device) and the wireless device (to receive the paging and WUS) revert to using WUS groups which are not for use in paging escalation (such as for conventional WUS-based paging, such as WUS groups for wireless devices which are still in their last connected cell).

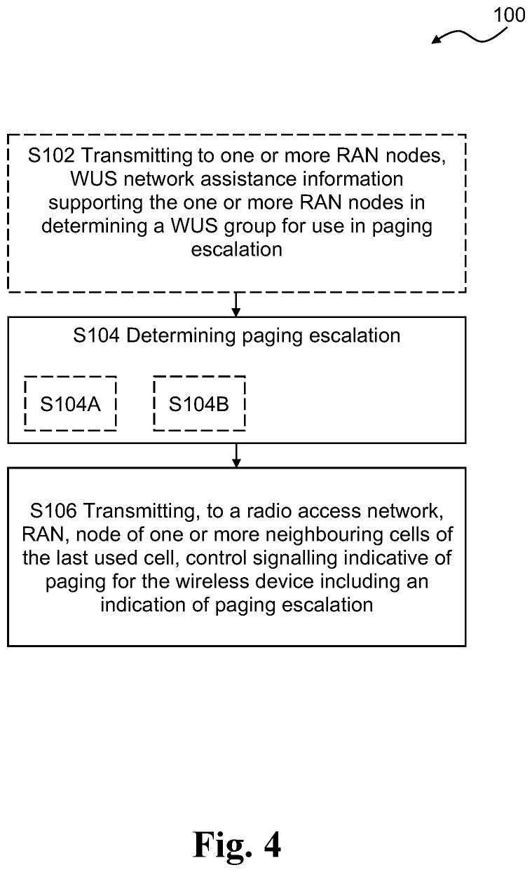

FIG. 4 shows a flow-chart illustrating an example method 100, performed in a core network node, for Wake-Up Signal, WUS, for paging a wireless device according to this disclosure,

The method 100 is performed by a core network node, such as the core network node disclosed herein, such as CN node 600 of FIGS. 1A, 7 and 8.

The method 100 comprises determining S104 paging escalation. In one or more example methods, determining S104 the paging escalation comprises transmitting S104A to the radio access network, RAN, node of the last used cell, control signalling indicative of paging for the wireless device. For example, the CN node attempts to page the wireless device in the last used cell. In one or more example methods, determining S104 paging escalation comprises failing S104B to receive a response to the control signalling indicative of paging for the wireless device transmitted in S104A.

The method 100 comprises transmitting S106, to a radio access network, RAN, node of one or more neighbouring cells of a last used cell for the wireless device, control signalling indicative of paging for the wireless device including an indication of paging escalation. For example, the control signalling indicative of paging for the wireless device including an indication of paging escalation comprises a paging message, such as a S1-AP (S1 Application protocol) paging message targeted at the wireless device and indicating that a paging escalation is triggered by the CN node.

In one or more example methods, the method comprises transmitting S102, to one or more RAN nodes, WUS network assistance information supporting the one or more RAN nodes in determining a WUS group for use in paging escalation. For example, the WUS network assistance information is sent to the RAN node(s) prior to paging escalation, for example when the cell-specific WUS configuration is defined or obtained. For example, the CN node sends to the RAN node configuration information, as WUS network assistance information. For example the configuration information comprises configuration which may be used in paging escalation. For example, WUS network assistance information may enable applying, at a RAN node, a predetermined set of rules to determine the WUS group for use in paging escalation. For example, the WUS network assistance information may be used by the RAN node to help determining the WUS group used when paging the wireless device. For example, the WUS network assistance information may comprise paging probability information. In other words, the CN node for example sends, to the RAN node, paging probability information as a “WUS network assistance information”. For example, the paging probability information provides a metric on the probability of a wireless device receiving a paging message based on, e.g., statistical information. Optionally, WUS network assistance information may be defined by specification and/or by management of the network (Operations, Administration and Maintenance, OAM). The CN node stores the WUS Assistance Information parameter in a context, such as MM context and provides it to the RAN node when paging the wireless device. WUS assistance information may be used interchangeable with WUS network assistance information in one or more embodiments.

For example, the information received by the wireless device may be indicative of a paging probability provided by the core network (e.g. in TS24.401 section 4.3.21.4.). For example, the wireless device may in the Attach Request message to the CN node provide its capability to support WUS Assistance Information. If WUS Assistance Information is supported, then the wireless device in the Attach Request or Tracking Area Update message may provide the additional UE paging probability information. The CN node, e.g. MME, may use the paging probability provided by the wireless device, local configuration and/or previous statistical information for the wireless device when determining the WUS Assistance Information. When the wireless device supports WUS Assistance Information, the CN node may assign WUS Assistance Information to the wireless device, even when the wireless device has not provided the additional UE paging probability information. When the CN node has determined WUS Assistance Information for the wireless device, the CN node provides it to the wireless device in every Attach Accept and/or Tracking Area Update message. The CN node stores the WUS Assistance Information parameter in a context, such as MM context and provides it to the RAN node when paging the wireless device.

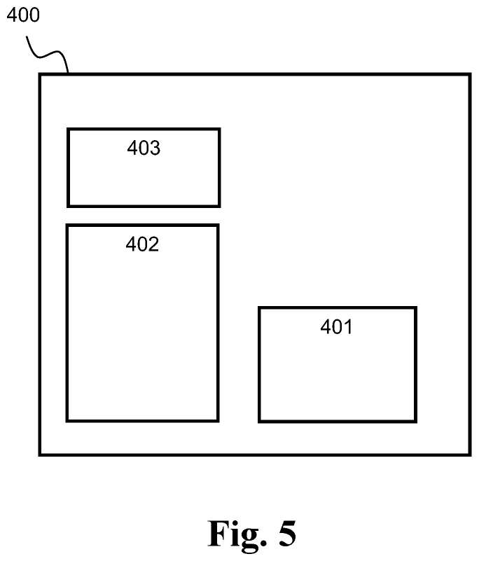

FIG. 5 shows a block diagram illustrating an example radio access network node 400 according to this disclosure. The present disclosure relates to a radio access network, RAN node 400 of a wireless communication system. Examples of a RAN node include a base station, an evolved NodeB (eNB), a gNB, and/or an access point.

The RAN node 400 comprises a memory circuit 401, a processor circuit 402, and a wireless interface 403. The RAN node 400 is configured to perform any of the methods disclosed herein, such as any of the methods shown in FIG. 2. The RAN node 400 may be configured for WUS transmission.

The wireless interface 403 is configured for wireless communications via a wireless communication system, such as a 3GPP system, such as a 3GPP system supporting MTC and/or NB-IoT, and/or supporting a device with reduced capability compared to a device supporting mobile broad band.

The RAN node 400 is configured to communicate with a wireless device (such as the wireless device disclosed herein), and a core network node (such as the core network node disclosed herein).

The RAN node 400 is configured to broadcast (e.g. via the wireless interface 403) information indicative of a WUS group for use in paging escalation.

The RAN node 400 is configured to receive (e.g. via the wireless interface 403) from a core network node, control signalling instructing the RAN node to page a wireless device, the control signalling being indicative of paging escalation.

The RAN node 400 is configured to transmit (e.g. via the wireless interface 403) WUS to the wireless device using the WUS group for use in paging escalation.

The processor circuit 402 is optionally configured to perform any of the operations disclosed in FIG. 2 (one or more of S201, S205, S206). The operations of the RAN node 400 may be embodied in the form of executable logic routines (e.g., lines of code, software programs, etc.) that are stored on a non-transitory computer readable medium (e.g., the memory circuit 403) and are executed by the processor circuit 402).

Furthermore, the operations of the RAN node 400 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuit 401 may be one or more of a buffer, a flash memory, a hard drive, a removable media, a volatile memory, a non-volatile memory, a random access memory (RAM), or other suitable device. In a typical arrangement, the memory circuit 401 may include a non-volatile memory for long term data storage and a volatile memory that functions as system memory for the processor circuit 402. The memory circuit 401 may exchange data with the processor circuit 402 over a data bus. Control lines and an address bus between the memory circuit 401 and the processor circuit 402 also may be present (not shown in FIG. 5). The memory circuit 401 is considered a non-transitory computer readable medium.

The memory circuit 401 may be configured to store information broadcasted and optionally WUS network assistance information.

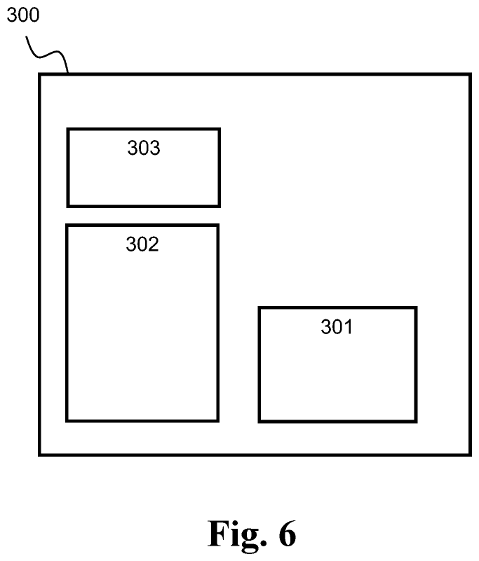

FIG. 6 shows a block diagram of an example wireless device 300 according to the disclosure. The wireless device 300 comprises a memory circuit 301, a processor circuit 302, and a wireless interface 303. The wireless device 300 may be configured to perform any of the methods disclosed in FIG. 3. In other words, the wireless device 300 may be configured for WUS reception.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution—Machine Type Communication, LTE-M, and an NR reduced capability device. The wireless device 300 is configured to communicate with a radio access network, RAN node, such as the RAN node disclosed herein, using a wireless communication system. The wireless device 300 is configured to upon entering a new cell, receive (e.g. using the wireless interface 303), from a RAN node of the new cell, information indicative of a WUS group for use in paging escalation.

The wireless device 300 is configured to monitor (e.g. using the wireless interface 303), based on the information received, for WUS in the WUS group indicated by the received information.

The wireless device 300 is optionally configured to perform any of the operations disclosed in FIG. 3 (such as any one or more of S301, S302, S303). The operations of the wireless device 300 may be embodied in the form of executable logic routines (for example, lines of code, software programs, etc.) that are stored on a non-transitory computer readable medium (for example, the memory circuit 301) and are executed by the processor circuit 302).

Furthermore, the operations of the wireless device 300 may be considered a method that the wireless device 300 is configured to carry out. Also, while the described functions and operations may be implemented in software, such functionality may as well be carried out via dedicated hardware or firmware, or some combination of hardware, firmware and/or software.

The memory circuit 301 may be one or more of a buffer, a flash memory, a hard drive, a removable media, a volatile memory, a non-volatile memory, a random access memory (RAM), or other suitable device. In a typical arrangement, the memory circuit 301 may include a non-volatile memory for long term data storage and a volatile memory that functions as system memory for the processor circuit 302. The memory circuit 301 may exchange data with the processor circuit 302 over a data bus. Control lines and an address bus between the memory circuit 301 and the processor circuit 302 also may be present (not shown in FIG. 6). The memory circuit 301 is considered a non-transitory computer readable medium.

The memory circuit 301 may be configured to store information (such as information indicative of the WUS group for use in paging escalation, e.g. SIB) in a part of the memory.

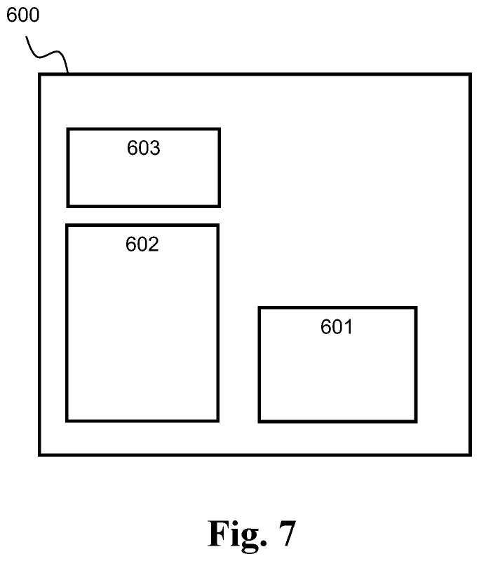

FIG. 7 shows a block diagram illustrating an example core network, CN, node 600 according to this disclosure. The CN node 600 comprises a memory circuit 601, a processor circuit 602, and an interface 603. The CN node 600 is configured to perform any of the methods disclosed herein, such as any of the methods shown in FIG. 4. The CN node 600 may be configured for paging a wireless device based on Wake-Up signal, WUS.

The interface 603 may be configured for wired and/or wireless communications via a wireless communication system, such as a 3GPP system, such as a 3GPP system supporting MTC and/or NB-IoT.

The CN node 600 is configured to communicate with a wireless device (such as the wireless device disclosed herein), and/or a RAN node (such as the RAN node disclosed herein).

The CN node 600 is configured to communicate with a wireless device for assistance information, such as negotiating the paging probability with the wireless device. The CN node 600 is configured to determine (e.g. using the processor circuit 602) paging escalation.

The CN node 600 is configured to transmit (e.g. via the wireless interface 603), to a radio access network, RAN, node of one or more neighbouring cells of a last used cell for the wireless device, control signalling indicative of paging for the wireless device including an indication of paging escalation. In other words, the CN node 600 is configured to transmit (e.g. via the wireless interface 603), to each of the RAN, nodes of the one or more neighbouring cells of a last used cell for the wireless device, the control signalling.

The processor circuit 602 is optionally configured to perform any of the operations disclosed in FIG. 4 (one or more of S102, S104A, S104B). The operations of the CN node 600 may be embodied in the form of executable logic routines (e.g., lines of code, software programs, etc.) that are stored on a non-transitory computer readable medium (e.g., the memory circuit 603) and are executed by the processor circuit 602).

Furthermore, the operations of the CN node 600 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuit 601 may be one or more of a buffer, a flash memory, a hard drive, a removable media, a volatile memory, a non-volatile memory, a random access memory (RAM), or other suitable device. In a typical arrangement, the memory circuit 601 may include a non-volatile memory for long term data storage and a volatile memory that functions as system memory for the processor circuit 602. The memory circuit 601 may exchange data with the processor circuit 602 over a data bus. Control lines and an address bus between the memory circuit 601 and the processor circuit 602 also may be present (not shown in FIG. 7). The memory circuit 601 is considered a non-transitory computer readable medium.

The memory circuit 601 may be configured to store WUS network assistance information, and/or MM context.

FIG. 8 shows a signalling diagram illustrating an example embodiment according to this disclosure. The signalling diagram involves a wireless device 300, a RAN node 400A of cell 1, a RAN node 400 of cell 2, and a CN node 600.

Optionally, the CN node 600 transmits (S102), to RAN nodes 400 and 400A, WUS network assistance information 701 supporting the one or more RAN nodes in determining a WUS group for use in paging escalation. This may be done for example at an initialization. The RAN nodes may also be preconfigured with the information to determine the WUS group for use in paging escalation. The RAN nodes 400 and 400A are capable of defining cell-specific WUS configurations including the WUS group for use in paging escalation.

The CN node can generate information regarding the WUS group for use in paging escalation, e.g. the temporary paging probability groups information, that is to be used for the mobile wireless devices. This may be advantageous as the CN node is aware of the UE potential traffic. The information regarding the WUS group for use in paging escalation can then be communicated to RAN node via S102 and 701 as WUS assistance information. The actual paging and WUS transmission are performed by the RAN nodes of the new cell, which can use this information to map this information to physical/actual WUS groups (or sequences).

Each of RAN nodes 400 and 400A broadcasts (S202) information 702, 702A (such as configuration) indicative of a WUS group for use in paging escalation in their respective cells, for example using SIB. For example, 702 is read by the wireless device 300 during or just after the cell reselection to cell 2.

The RAN node 400A may release 704 the wireless device 300 to Idle mode if the wireless device was in Connected mode.

The CN node 600 transmits to the radio access network, RAN, node 400A of the last used cell, control signalling 705 indicative of paging for the wireless device. The RAN node 400A pages 706 the wireless device 300 in cell 1. For example, the CN node 600 attempts to page the wireless device 300 in the last used cell, cell 1. The CN node 600 fails to receive a response 707, 708 to the control signalling 706 indicative of paging for the wireless device transmitted. This way, the CN node 600 determines S104 paging escalation.

The CN node 600 transmits (S106), to a radio access network, RAN, node 400 of cell 2 for the wireless device, control signalling 709 indicative of paging for the wireless device including an indication of paging escalation. The control signalling 709 may comprise a paging message for the wireless device and indication of the last used cell(s) of the wireless device 300: cell 1. The RAN node 400 determines that cell 2 is not in “Last used cell(s)”.

The RAN node 400 transmits (S208) WUS 710 (and paging) to the wireless device 300 using the WUS group for use in paging escalation. The wireless device 300 responds to the paging.

The RAN node 400 establishes an RRC connection 711 with the wireless device 300 paged using the WUS group for use in paging escalation.

The RAN node 400 may, at some point, release 713 the wireless device 300 to a power-saving mode (such as Idle mode, such as RRC Idle and/or RRC Inactive).

The CN node establishes the connection and releases in 712.

The RAN node 400 (when sending WUS and paging the wireless device) and the wireless device 300 (to receive the paging and WUS) revert in 713, 714 to using WUS groups which are not for use in paging escalation (such as for conventional WUS-based paging, such as WUS groups for wireless devices which are still in their last connected cell).

Embodiments of methods and products (RAN node, CN node and wireless device) according to the disclosure are set out in the following items:
1. A method, performed by a Radio Access Network, RAN, node, for Wake-Up Signal, WUS transmission, the method comprising:
   broadcasting (S202) information indicative of a WUS group for use in paging escalation,
   receiving (S204), from a core network node, control signalling instructing the RAN node to page a wireless device, the control signalling being indicative of paging escalation, and
   transmitting (S208) WUS to the wireless device using the WUS group for use in paging escalation.
2. The method according to item 1, the method comprising
   detecting (S205), based on the control signalling received, the paging escalation.
3. The method according to any of the previous items, wherein the information is broadcasted via system information.
4. The method according to any of the previous items, wherein the information comprises a WUS group identifier of the WUS group for use in paging escalation.
5. The method according to any of the previous items, wherein the information comprises a paging probability configuration for the WUS group for use in paging escalation.
6. The method according to any of the previous items, the method comprising communicating (S201), between the core network node and the RAN node, WUS network assistance information.
7. The method according to any of the previous items, the method comprising: determining (S206), based on the WUS network assistance information, the WUS group for use in paging escalation.
8. The method according to item 7, wherein the determined WUS group for use in paging escalation comprises a dedicated WUS group.
9. The method according to any of items 7-8, wherein the determined WUS group for use in paging escalation comprises a WUS group associated with a predetermined paging probability and/or a pre-existing WUS group.
10. The method according to any of items 2-9, wherein detecting (S205) the paging escalation is based on that the one or more wireless devices are not reachable in their last used cells.
11. The method according to any of items 2-10, wherein detecting (S205) the paging escalation is based on that the wireless device has left their last used cells.
12. The method according to any of items 2-11, wherein detecting (S205) the paging escalation is based on that the wireless device experiences a channel quality from their last used cells that is below a threshold.
13. A method, performed by a wireless device, for Wake-Up Signal, WUS, reception, the method comprising:
   upon entering a new cell, receiving (S304), from a RAN node of the new cell, information indicative of a WUS group for use in paging escalation, and
   monitoring (S306), based on the information received, for WUS in the WUS group indicated by the received information.
14. The method according to item 13, the method comprising: obtaining (S301) information supporting the wireless device in determining a WUS group.
15. The method according to any of items 13-14, the method comprising:
   monitoring (S302) for WUS in a first WUS group based on the information obtained in (S301); and
   performing (S303) a cell-reselection to the new cell.
16. The method according to any items of 13-15, wherein the information indicative of the WUS group for use in paging escalation is received via system information.
17. The method according to any of items 13-16, wherein the information indicative of the WUS group for use in paging escalation comprises a WUS group identifier of the WUS group for use in paging escalation.
18. The method according to any of items 13-17, wherein the information indicative of the WUS group for use in paging escalation comprises a paging probability configuration for the WUS group for use in paging escalation.
19. A method, performed by a core network node, for Wake-Up Signal, WUS, for paging a wireless device, the method comprising:
   determining (S104) paging escalation; and
   transmitting (S106), to a radio access network, RAN, node of one or more neighbouring cells of a last used cell for the wireless device, control signalling indicative of paging for the wireless device including an indication of paging escalation.
20. The method according to item 19, the method comprising:
   transmitting (S102), to one or more RAN nodes, WUS network assistance information supporting the one or more RAN nodes in determining a WUS group for use in paging escalation.
21. The method according to any of items 19-20, wherein determining (S104) paging escalation comprises:
   transmitting (S104A) to the radio access network, RAN, node of the last used cell, control signalling indicative of paging for the wireless device,
   failing (S104B) to receive a response to the control signalling indicative of paging for the wireless device transmitted in (S104A).
22. A radio network node comprising a memory circuit, a processor circuit, and a wireless interface, wherein the radio network node is configured to perform any of the methods according to any of items 1-12.
23. A wireless device comprising a memory circuit, a processor circuit, and a wireless interface, wherein the wireless device is configured to perform any of the methods according to any of items 13-18.
24. A core network node comprising a memory circuit, a processor circuit, and a wireless interface, wherein the core network node is configured to perform any of the methods according to any of items 19-2.

The use of the terms “first”, “second”, “third” and “fourth”, “primary”, “secondary”, “tertiary” etc. does not imply any particular order, but are included to identify individual elements.

Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-8 comprises some circuits or operations which are illustrated with a solid line and some circuits or operations which are illustrated with a dashed line. The circuits or operations which are comprised in a solid line are circuits or operations which are comprised in the broadest example embodiment. The circuits or operations which are comprised in a dashed line are example embodiments which may be comprised in, or a part of, or are further circuits or operations which may be taken in addition to the circuits or operations of the solid line example embodiments. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuits may include routines, programs, objects, components, data structures, etc. that perform specified tasks or implement specific abstract data types. Computer-executable instructions, associated data structures, and program circuits represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

### APPENDIX 1

Agenda item: 7.2.3

### Source: Sony

Title: On supporting UE group WUS operation with mobility

### Document for: Discussion and Decision

### 1 Introduction

At RAN2#109-e meeting the following agreements and FFS were noted in [1];

Agreements:
For NB-IoT, RAN2 agree signaling changes proposed in Table
5 as the baseline.
For NB-IoT, RAN2 assume the changes proposed in Table 7, 8
and 9 as the baseline for signalling group WUS information.
For NB-IoT, RAN2 use the changes proposed in Table 10 as
the baseline.
For eMTC, RAN2 agree to use the changes proposed in Table
12 as the baseline.
For eMTC, RAN2 assume the changes proposed in Table 15,
16 and 17 as the baseline for signalling group WUS
information.

Agreements:
For eMTC and NB-IoT support the same paging probability
range and granularity.
No special handling of WUS resource overlap is specified and
UE use the WUS resource corresponding to its gap capability
Update stage 2 to explain group WUS in more detail using text
proposed in R2-2000639 as starting point.
From RAN2 point of view paging escalation does not need to
be mandated
Working assumption:
For NB-IoT, if only one R16 WUS resource is configured and
no Release 15 WUS resource is configured then R16 WUS
resource is always in primary location
Support of Release 16 WUS is independent to support of
Release 15 WUS
Define WUS group selection based on the formula defined in
R2-2001472
FFS:
Code points for paging probability thresholds.
Mechanism to minimize false wake-up

In this contribution, we discuss some aspects related to “mechanism to minimize false wake-up” taking into account UEs that are moving between different cells, causing paging escalation from the MME.

### 2 Discussion

Wake-up signal (WUS) grouping is introduced in Rel 16 for both NB-IoT and eMTC UEs to reduce the number of false UE wake-ups and thereby its associated energy cost. While the existing WUS grouping reduces the cost for UEs within a certain cell, the WUS grouping functionality is not optimal for scenarios where the UEs move between cells. A UE that moves around within a tracking area and receive lots of paging can destroy WUS benefits for all the WUS UEs in the same tracking area.

The issue is elaborated in the following example. Assume there are several UEs and each UE is located in a different cell but all cells serving these UEs belong to the same tracking area. Assume also these UEs has certain paging probability and therefore they have been assigned to monitor the channel for the same WUS group 1. The UE located in cell #1 is typically paged by the network in its last connected cell, in this case cell #1. If the UE moves (during idle mode) to cell #2, (for example, cell #2 being a part of the same Tracking Area as cell #1 in some embodiments), the first paging attempt in the last connected cell (cell #1) will fail since the network is not aware of the UE movement. The network will then perform paging escalation by also paging the UE in the neighbor cell(s). In this example, cell #2, cell #3, and cell #7. These cells will transmit wake up signal to the UEs belonging to WUS group 1. The problem is all UEs belong to WUS group 1 in those multiple cells will falsely be woken up, resulting in extra energy cost for those UEs.

In Rel 15, this is solved by the MME including “last used cell ID” in the S1 paging to all eNBs (so that the eNB knows that it is not the last used eNB) and the UEs are modified so that they do not use WUS in any cell other than the last used cell [2,3 ]. However, this solution would, limit the benefit of WUS for UEs that are moving between cells, preventing the use of WUS in case of paging escalation as the MME will page the UE in surrounding neighbor cells.

In Rel 16 where WUS grouping (GWUS) has been introduced, the following is proposed in [4] to address WUS grouping and UE mobility.
Option 1: The same solution for Rel-15 WUS can be reused, i.e., both WUS and GWUS are used in the last used cell only. When the UE reselect to another cell, it monitors legacy paging even WUS/GWUS are configured in the new cell.
Option 2: A default WUS group can be used to wake up the mobile UE, i.e. when the UE reselects to another cell, it monitors a default WUS group.
   Option 2a: The default WUS group for the UE with the highest or without paging probability is used for the mobile UE also.
   Option 2b: A separate default WUS group is used for the mobile UE.

In the analysis it is argued that compared with Option 1, the only benefit of Option 2 is that the mobile UE can also benefit from WUS. Further, the document discusses that for this type of mobile UEs which are typically in good coverage, the benefit from WUS is rather limited.

Observation 1: Option 1 has been proposed as a single solution for both Rel-15 WUS and Rel-16 GWUS.

In [5], it is proposed that mobile UEs monitor another WUS sequence after cell change. For example it is proposed to have one WUS UE group to be set aside for this purpose (i.e.

among all WUS resources for a given WUS gap).

Observation 2: The possibility of using another mechanism for handling UEs that are moving between cells are proposed.

Based on the open issue from the last meeting, and as observed in Observation 2, there is a need to introduce some sort of mechanism for handling the risk of unnecessary false wake-up of UEs that are not moving between cells.

From the reasoning it becomes clear that there is a need to distinguish idle mode UEs that are moving between cells from those idle mode UEs that remains stationary or remains in the same cell.

Observation 3: Moving UEs needs to be treated separately from stationary UEs, in order to reduce false wake-up.

We propose to include an additional WUS grouping to support mobility as well as to reduce false wake-up of UEs that have not been moving between different cells. The mechanism is elaborated as follows and illustrated in FIG. 1C. Assume the UE is originally in cell #1 and it has been assigned to WUS group 1. Once the UE moves to a new cell and the network cannot find the UE in the last known cell, the MME will initiate to page the UE in the neighbor cell(s) and indicate the UE belong to the mobility group (e.g. UE group TEMP). Once the neighbor cell(s) receives that indication, it starts to page the UE in the UE group TEMP. Unlike the previous case as described in FIG. 1B, Here UE group 1 in cell #2, #3, #7 remains “sleeping”. Hence, there is no false-wake-up.

As shown above, it would be beneficial to re-group the UEs that has made a cell reselection or moved to another cell, after being released to Idle, to a temporary WUS group, This group is used only used for UEs that are mobile. Through this, all UEs that are configured to use Wake-up signal, would use this temporary WUS group as long as they are doing cell reslection. Once they are paged and being in connection, they go back and use the legacy WUS group while remaining in the cell they were released to.

Proposal 1: UEs that are moving between cells are group in a temporary WUS group as long as the UEs are camping on a cell that is different from the cell that it was released into Idle.

Proposal 2: Once the UE can be paged, the UE changes its WUS group from temporary WUS group to the previous WUS group (e.g. the group based on paging probability).

From WUS configuration in system information, the UE would have information on the possibility to temporary change the current WUS group to a temporary WUS group, and further into which WUS resource and WUS sequence the UE needs to listen for.

Proposal 3: eNB provides additional WUS configuration so that the UE can identify which temporary WUS group to be used when performing cell reselection between cells.

### 3 Conclusions

In this contribution, the following observations and proposals are made:

Observation 1: Option 1 has been proposed as a single solution for both Rel-15 WUS and Rel-16 GWUS.

Observation 2: The possibility of using another mechanism for handling UEs that are moving between cells are proposed.

Observation 3: Moving UEs needs to be separated from stationary UEs, in order to reduce false wake-up.

Proposal 1: UEs that are moving between cells are group in a temporary WUS group as long as the UEs are camping on a cell that is different from the cell that it was released into Idle.

Proposal 2: Once the UE can be paged, the UE changes its WUS group from temporary WUS group to the previous WUS group (e.g. the group based on paging probability).

Proposal 3: eNB provides additional WUS configuration so that the UE can identify which temporary WUS group to be used when performing cell reselection between cells.

[1]. Minutes RAN2#109-e meeting

[2]. S2-2002552 (Rel-15)

[3]. S2-2001686 (Rel-16)

[4]. R2-2000639

[5]. R2-2001472

1. A method, performed by a Radio Access Network (RAN) node, for Wake-Up Signal (WUS), transmission, the method comprising: broadcasting information indicative of a WUS group for use in paging escalation, receiving, from a core network node, control signalling instructing the RAN node to page a wireless device, the control signalling being indicative of paging escalation, and transmitting WUS, to the wireless device, using the WUS group for use in paging escalation.

2. The method according to claim 1, the method comprising detecting, based on the control signalling received, the paging escalation.

3. The method according to claim 1, wherein the information is broadcasted via system information.

4. The method according to claim 1, wherein the information comprises a WUS group identifier of the WUS group for use in paging escalation.

5. The method according to claim 1, wherein the information comprises a paging probability configuration for the WUS group for use in paging escalation.

6. The method according to claim 1, the method comprising communicating, between the core network node and the RAN node, WUS network assistance information.

7. The method according to claim 1, the method comprising: determining, based on the WUS network assistance information, the WUS group for use in paging escalation.

8. The method according to claim 7, wherein the determined WUS group for use in paging escalation comprises a dedicated WUS group.

9. The method according to claim 7, wherein the determined WUS group for use in paging escalation comprises a WUS group associated with a predetermined paging probability and/or a pre-existing WUS group.

10. The method according to claim 2, wherein detecting the paging escalation is based on that the one or more wireless devices are not reachable in their last used cells.

11. The method according to claim 2, wherein detecting the paging escalation is based on that the wireless device has left their last used cells.

12. The method according to claim 2, wherein detecting the paging escalation is based on that the wireless device experiences a channel quality from their last used cells that is below a threshold.

13. A method, performed by a wireless device, for Wake-Up Signal (WUS), reception, the method comprising: upon entering a new cell, receiving, from a RAN node of the new cell, information indicative of a WUS group for use in paging escalation, and monitoring, based on the information received, for WUS in the WUS group indicated by the received information.

14. The method according to claim 13, the method comprising: obtaining information supporting the wireless device in determining a WUS group.

15. The method according to claim 13, the method comprising: monitoring for WUS in a first WUS group based on the information obtained in; and performing a cell-reselection to the new cell.

16. The method according to claim 13, wherein the information indicative of the WUS group for use in paging escalation is received via system information.

17. The method according to claim 13, wherein the information indicative of the WUS group for use in paging escalation comprises a WUS group identifier of the WUS group for use in paging escalation.

18. The method according to claim 13, wherein the information indicative of the WUS group for use in paging escalation comprises a paging probability configuration for the WUS group for use in paging escalation.

19. A method, performed by a core network node, for Wake-Up Signal (WUS), for paging a wireless device, the method comprising: determining paging escalation; and transmitting, to a radio access network (RAN), node of one or more neighbouring cells of a last used cell for the wireless device, control signalling indicative of paging for the wireless device including an indication of paging escalation.

20. The method according to claim 19, the method comprising: transmitting, to one or more RAN nodes, WUS network assistance information supporting the one or more RAN nodes in determining a WUS group for use in paging escalation.

21-24. (canceled)
